(19) United States
(12) Patent Application Publication
(10) Pub. No.: US 2024/0107336 A1
(43) Pub. Date: Mar. 28, 2024

(54) REMOTE COMMUNICATIONS SYSTEM AND METHOD

(71) Applicant: GBA SYSTEMS INTEGRATORS, LLC, Lenexa, KS (US)

(72) Inventor: James L. Gilbert, Eudora, KS (US)

(21) Appl. No.: 18/257,970

(22) PCT Filed: Dec. 15, 2021
(86) PCT No.: PCT/US2021/063554

§ 371 Date: Jun. 16, 2023

Related U.S. Application Data
(60) Provisional application No. 63/127,500, filed on Dec. 18, 2020.

(51) Int. Cl. H04W 24/02

(52) U.S. Cl. CPC H04W 24/02; H04W 84/12

(57) ABSTRACT

A rapidly deployable communications system for use in remote and austere environments having at least one base station (primary) enclosed in a ruggedized container. The base station includes a distribution module and a network module. The distribution module includes a Wi-Fi access point for up 250 devices. The network module is securely mounted in the ruggedized container and is coupled in communication with the distribution module. The network module includes a cellular backhaul including a cellular modem coupled in communication with a cellular network. One or more additional base stations and/or distribution modules may be coupled in communication with the primary base station and/or each other. The additional base stations, the additional distribution modules, and the primary base station may be coupled in communication to each other via Wi-Fi meshing and/or longer range radio communications.

### CROSS-REFERENCE TO RELATED APPLICATIONS

This application claims the priority benefit of identically titled U.S. Provisional Patent Application No. 63/127,500, filed Dec. 18, 2020, the entirety of which is incorporated herein by reference.

### BACKGROUND

The present disclosure relates to a rapidly deployable communications system for use in remote and austere environments. The system enables users/organizations to quickly establish internet access and VoIP communications from any fixed or stationary location on earth. Known remotely deployable communications systems are typically limited concerning power sourcing, ease of setup and use, scalability, portability, and/or network connectivity. Accordingly, the known available communications systems all have shortcomings because of inherent design limitations and/or failure to incorporate the entire feature set of the present invention within a single, portable system.

### SUMMARY

This summary is provided to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present disclosure will be apparent from the following detailed description of the embodiments and the accompanying drawing figures.

In one aspect, a base station is provided. The base station includes a ruggedized container, a distribution module, and a network module. The distribution module includes a Wi-Fi access point. The network module is securely mounted in the ruggedized container and coupled in communication with the distribution module. The network module includes a cellular backhaul having a cellular modem coupled in communication with a cellular network. The network module also includes a network switch and a network security appliance. The network security appliance is coupled in communication with the cellular modem and the network switch. The network security appliance is located between the cellular modem and the network switch such that data communications between the cellular modem and the network switch pass through the network security appliance.

In another aspect, a rapidly deployable communications system is provided. The system includes first and second base stations and one or more additional distribution modules. The first base station includes a first distribution module having a first wireless communication device. The first base station also includes a first network module. The first network module includes a cellular backhaul having a cellular modem coupled in communication with a cellular network for providing a first internet source. In addition, the first base station includes a first plurality of inlet/outlet ports. The second base station includes a second distribution module having a second wireless communication device. The second base station also includes a second network module. The second network module includes a second plurality of inlet/outlet ports. Each of the one or more additional distribution modules include an additional wireless communication device. Each of the first plurality of inlet/outlet ports and the second plurality of inlet/outlet ports include connectors configured to be unique for each respective port to prevent incorrect assembly thereof. Furthermore, the second base station and the one or more additional distribution modules are coupled in wireless communication with the first base station via the first wireless communication device, the second wireless communication device, and the additional wireless communication devices. Multiple distribution modules can be connected to any base stations creating an area-wide meshed network.

Advantages of these and other embodiments will become more apparent to those skilled in the art from the following description of the exemplary embodiments which have been shown and described by way of illustration. As will be realized, the present embodiments described herein may be capable of other and different embodiments, and their details are capable of modification in various respects. Accordingly, the drawings and description are to be regarded as illustrative in nature and not as restrictive.

### BRIEF DESCRIPTION OF THE FIGURES

The Figures described below depict various aspects of systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a schematic overview of an exemplary communication network platform or system;

FIG. 2 is a front view of an exemplary base unit of the communication network platform shown in FIG. 1;

FIG. 3 is a schematic of various internal components of a network module of the base unit shown in FIG. 2;

FIG. 4 is a schematic of an exemplary power module coupled to a plurality of optional external power sources, in accordance with one aspect of the invention;

FIG. 5 is a front view of the power module shown in FIG. 4;

FIG. 6 is a schematic of various internal components of the power module shown in FIGS. 4 and 5;

FIG. 7 is a flowchart illustrating an exemplary computer-implemented method for deploying a secure telecommunications infrastructure, such as the communication network platform or system shown in FIG. 1, in remote and/or austere environments; and

FIG. 8 is a flowchart illustrating another exemplary computer-implemented method for deploying a secure telecommunications infrastructure, such as the communication network platform or system shown in FIG. 1, in remote and/or austere environments.

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein. While the drawings do not necessarily provide exact dimensions or tolerances for the illustrated components or structures, the drawings are to scale with respect to the relationships between the components of the structures illustrated in the drawings.

### DETAILED DESCRIPTION

The following detailed description of embodiments of the disclosure references the accompanying figures. The embodiments are intended to describe aspects of the disclosure in sufficient detail to enable those with ordinary skill in the art to practice the disclosure. The embodiments of the disclosure are illustrated by way of example and not by way of limitation. Other embodiments may be utilized, and changes may be made, without departing from the scope of the claims. The following description is, therefore, not limiting. The scope of the present disclosure is defined only by the appended claims, along with the full scope of equivalents to which such claims are entitled.

Broadly, this disclosure is directed to a rapidly deployable communication network platform. More particularly, the disclosure is directed to a turnkey, secure, scalable, portable, and ruggedized network solution that provides broadband coverage to virtually any location or area in which the communication network platform is deployed. The communication network platform can easily be deployed by non-technical personnel to support computing device (e.g., computers, VoIP handsets, laptops, printers, Wi-Fi Cell phones, and the like) connections to the internet or locally. The secure network platform uses a next generation firewall and modern AI managed meshed field nodes, configurable to end-user needs and specifications. The communication network platform is designed to be easy to transport, physically handle, set up, and operate. The communication network platform facilitate access to the internet and other communication networks through user selected satellite, wired (e.g., copper/optical fiber), cellular, and/or broadband radio connections.

The communication network platform is configured to operate such that any modern Wi-Fi capable device can connect to and through the communication network platform to the internet using one or more connection methods, including, for example, satellite (L, C, Ka and/or Ku bands with parabolic or flat panel self-acquiring antennas), wired wide area network (WAN) and/or local area network (LAN) (e.g., via copper wire, fiber optic cable, etc.), wireless point-to-point (P2P), and cellular (e.g., 5G (fifth generation technology standard for broadband cellular networks)). The communication network platform is secure and scalable, including providing between one (1) to two hundred and fifty (250) Wi-Fi connections per base unit, as described herein. The communication network platform incorporates an IEEE 802.11 standard Wi-Fi node, which provides a radius of access of about three hundred and thirty meter (330 m). The Wi-Fi node incorporates Blockchain and advanced multi-user, multiple-input, multiple-output (MU-MIMO) wave 2 protocols. As described herein, each base unit can connect to one or more additional base units via Wi-Fi communications, five gigahertz (5 GHz) radio communications, and/or long distance P2P broadband radio communications.

The communication network platform is configured to accept electrical power from any available power generation source. The communication network platform normalizes the provided power to twenty-four volts direct current (24 VDC). The communication network platform includes one or more internal batteries, which provide power redundancy and bridging power capabilities when the primary power source is disrupted and/or changed. The communication network platform incorporates unique, weather-resistant cables and plugs to facilitate easy, correct connection, for example, between modules (e.g., a network module, distribution module, and/or power module).

As such, the communication network platform enables people and organizations located in remote and/or austere environments to quickly set up a secure telecommunications infrastructure for phone and internet access. The easily and rapidly deployable communication network platform is configured to fit within one or more ruggedized containers (e.g., clam shell cases). The ruggedized containers are suitable for difficult environments and are designed to function in a temperature range between about negative twenty degrees Celsius (−20° C.) and about seventy degrees Celsius (70° C.). The ruggedized containers are sized to be about, or less than, twenty-six inches (26 in.) by about twenty-six inches (26 in.) by about sixteen inches (16 in.). In addition, the ruggedized containers, when fully equipped, are configured to weigh less than about fifty pounds (50 lbs.) (excluding external batteries, portable generator, Wi-Fi access point, micro grid solar panels, wind turbine, satellite antenna, and/or antenna pole, if needed).

The communication network platform is configured to withstand winds up to and including about one hundred and forty kilometers per hour (140 km/hr), operate in an environment with a humidity level in the range between and including about five percent (5%) and about ninety-five percent (95%), and resist a lightning strike resistant (i.e., the communication network platform is 5000-amp surge tolerant per IEC 61000-4-5). Remote monitoring and support of the communication network platform is available to ensure proper setup and operation.

### Exemplary System

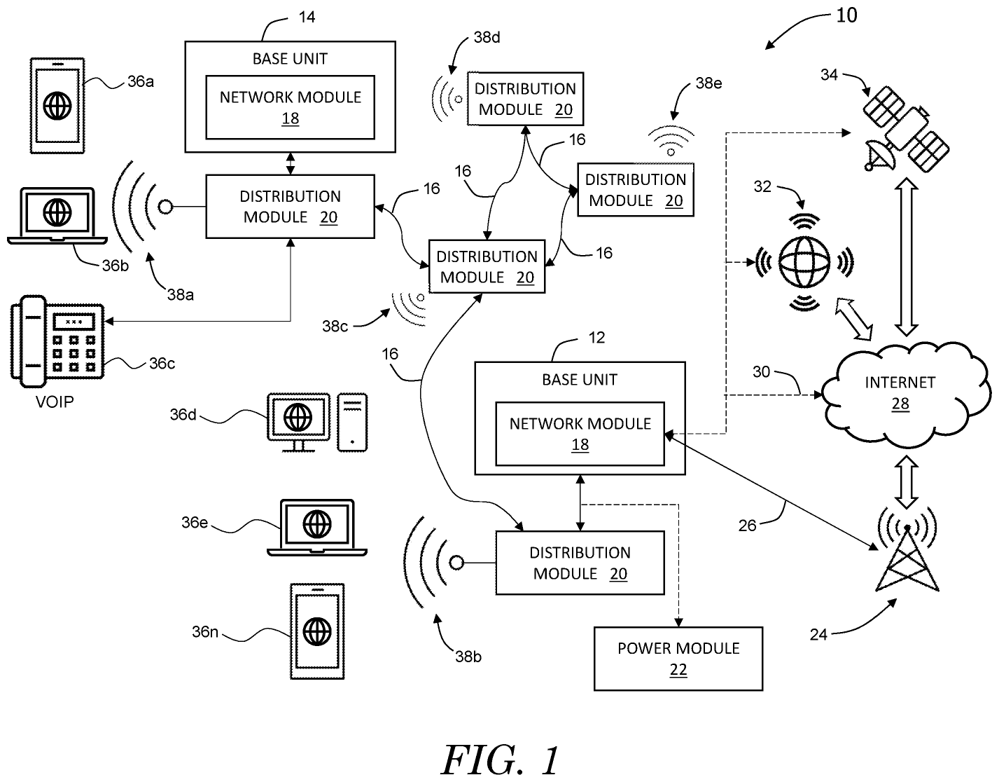

FIG. 1 is a schematic overview of an exemplary communication network platform 10 (or system). In the example embodiment, the system 10 includes a first terrestrial base unit 12 (or base station), an optional second terrestrial base unit 14 (or base station), and a plurality of distribution modules 20 coupled in communication, as indicated by communication links 16. It is noted that the first and second base units 12, 14 are substantially the same, differing only in network connections, as depicted in FIG. 1 and described herein. The communication links 16 may utilize, for example, one or more of Wi-Fi meshing, 5 Ghz short distance radio link(s), and/or long-distance point-to-point (P2P) radio link(s) for connection of the base unit 14 and/or the base unit 12 to the plurality of mesh distribution modules 20. In the example depicted in FIG. 1, the base unit 12 functions as a primary base unit (i.e., the base unit is connected to the internet 28) and the optional base unit 14 functions as a secondary base unit (i.e., a base unit that gets its internet connection from the primary base unit via the communication links 16).

It is contemplated that the system 10 may include one primary base unit (e.g., the base unit 12) and may include two or more secondary base units (e.g., the base unit 14) and/or distribution modules 20, each of which is coupled in communication with the primary base unit and/or with each other. In certain embodiments, larger systems may include two or more primary base units with respective secondary base units coupled in communication therewith. The secondary base unit(s) and/or distribution modules typically only mesh/communicate with one primary base unit at a time. It is contemplated, however, that the secondary base unit(s) and/or distribution modules can be programmed to automatically switch communication to a different primary base unit as desired (e.g., if its initial base unit fails).

The example system 10 depicted in FIG. 1 will be described herein as including both a primary base station 12 and a secondary base station 14. As noted above, however, the secondary base station 14 is optional. In the exemplary embodiment, the base units 12, 14 include a network module 18 and a connected distribution module 20. In certain aspects, one or more of the base units 12, 14 may be coupled to an optional power module 22. The power module 22 is configured to provide electrical power to the base unit(s) 12, 14, for example, when a typical local power grid connection is unavailable (e.g., a 120-240 VAC electrical grid power). The power module 22 can be a separately contained compartment of the base unit 12, 14, with input ports for receiving power from the one or more power sources and at least one output port for supplying power to the base units 12, 14, for example, via the network module 18.

The base unit 12, 14 and the power module 22 are preferably separately compartmentalized in respective ruggedized containers (not shown in FIG. 1) for withstanding harsh conditions, protecting the internal components, and to maintain the portable nature of the base units 12, 14. The base unit 12, 14 and the power module 22, when separated, are more easily portable and can be coupled together at the desired location. Preferably, the ruggedized containers are locked, the internal compartments of which are configured to inhibit easy access. In certain embodiment, semi-permanent sealing of the compartments and/or cushioning of the internal components further contributes to the ability of the base unit 12, 14 and the power module 22 to perform under harsh conditions.

In the example embodiment, the network module 18 of the base unit 12 (i.e., the primary base unit) is coupled in communication to a cellular network 24, as indicated at 26, for example, to access the internet 28. In certain aspects of the present disclosure, the network module 18 may be coupled to the internet 28 via one or more internet backhaul links provided by one or more of a wired connection 30 (e.g., copper/optical fiber) (a wired backhaul), a WAN connection 32 (a WAN backhaul), and/or a satellite connection 34 (a satellite backhaul). While the wired connection 30, WAN connection 32, and WAN connection 32 are depicted in FIG. 1, it is contemplated that in certain embodiments, the system 10 may include additional add-on and/or “special modules” that contain user defined IP enabled communication equipment that connects directly to the base unit 12, 14 to add long distance, wide-area transmission capabilities to the system 10. For example, modules may include small 4G cellular broadcasters and receivers, HAM type radio systems, AM/FM/TV broadcast equipment, and other types of communication equipment that utilize various licensed and unlicensed broadband wavelengths. Any add-on and/or special module that is incorporated into a RUCS installation would meet the same size, weight, power, and unique connector criteria described herein with respect to the base unit(s) 12, 14. In certain other aspects of the present disclosure, two or more network modules 18 of the base units 12, 14 may be deployed and connected to the internet 28. In such an embodiment, the respective network modules 18 may be connected to different internet services such that multiple types of internet backhauls can be utilized in the system 10, for example, for redundancy purposes.

Each distribution module 20 in the system 10 contains one or more wireless networking components (not shown in FIG. 1) that provide wireless communication between one or more base units 12, 14 (as indicated at 16) and one or more user computing devices 36a-n. Each base unit 12,14 can connect to up to twenty (20) distribution modules 20 to create an areawide meshed system 10. The wireless networking components provide wireless access points 38a, 38b that transmit a wireless signal and collectively establish a wireless network covering a designated area of coverage depending upon the location and configuration of the base units 12, 14 relative to each other. In one example, each distribution module 20 includes an 802.11ax Wi-Fi access point (or node) that provides a Wi-Fi coverage area of approximately one thousand feet (1,000 ft) radius. In certain aspects of the invention, each distribution module 20 includes long range wireless communication such that each distribution module 20 can be positioned up to five kilometers (5 km) from a respective distribution module 20 without loss of communication. For example, the long-range wireless communication may be provided by five gigahertz (5 GHz) radios providing up to a five kilometer (5 km) connection range. In other embodiments, each base unit 12, 14 can be configured to transmit and receive conventional radio signals with a longer range (e.g., up to sixty kilometers (60 km)), depending upon line-of-sight limitations as well as the height/location of antenna positioning. For example, for longer range communications, long distance point-to-point (P2P) broadband radio links may be established between respective base units 12, 14 without loss of communication. It will be appreciated that the base unit(s) 12, 14 and the distribution modules 20 can thus be positioned and arranged to maximize the area of coverage and/or to minimize communications gaps or dead zones, as desired.

Compatible user computing devices 36a-n can connect to the distribution modules 20 via the wireless access points 38a, 38b and access the internet or other communications networks (e.g., cellular, satellite, LAN, WAN, etc.) accordingly. Each individual distribution module 20 can support up to 250 simultaneous Wi-Fi connections. For example, if there is one (1) primary base unit 12 and three (3) distribution modules 20 in a meshed and/or connected system 10, the system 10 can support up to seven hundred and fifty (750) Wi-Fi connections. As depicted in FIG. 1, exemplary user devices 36a-n include, for example, personal computer desktops and laptops; various smart devices, such as smartphones and tablets; voice over IP (VoIP) phones; smart TVs; printers; smart speakers; voice assistants; wireless connectible vehicles; drones; and the like.

### Exemplary Base Unit

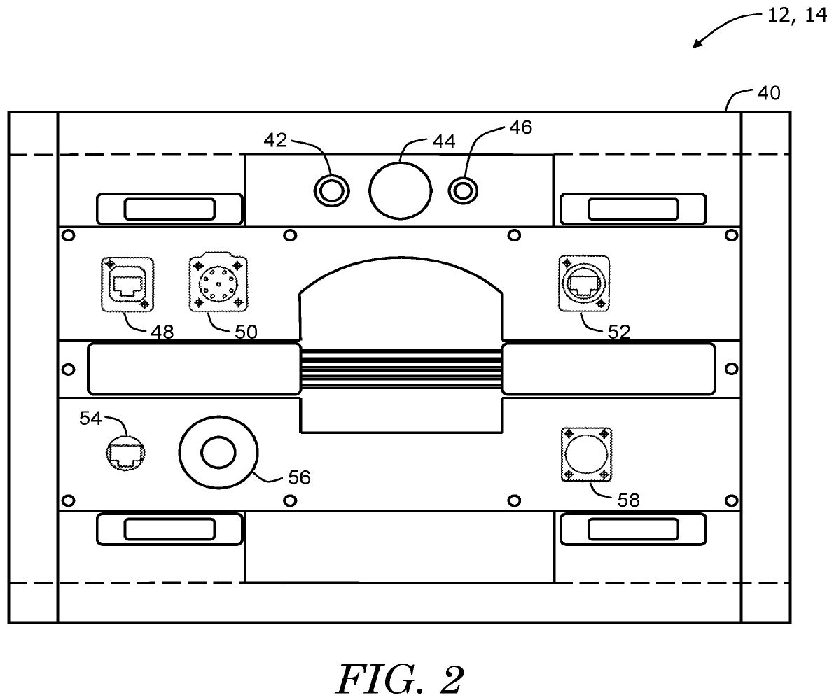

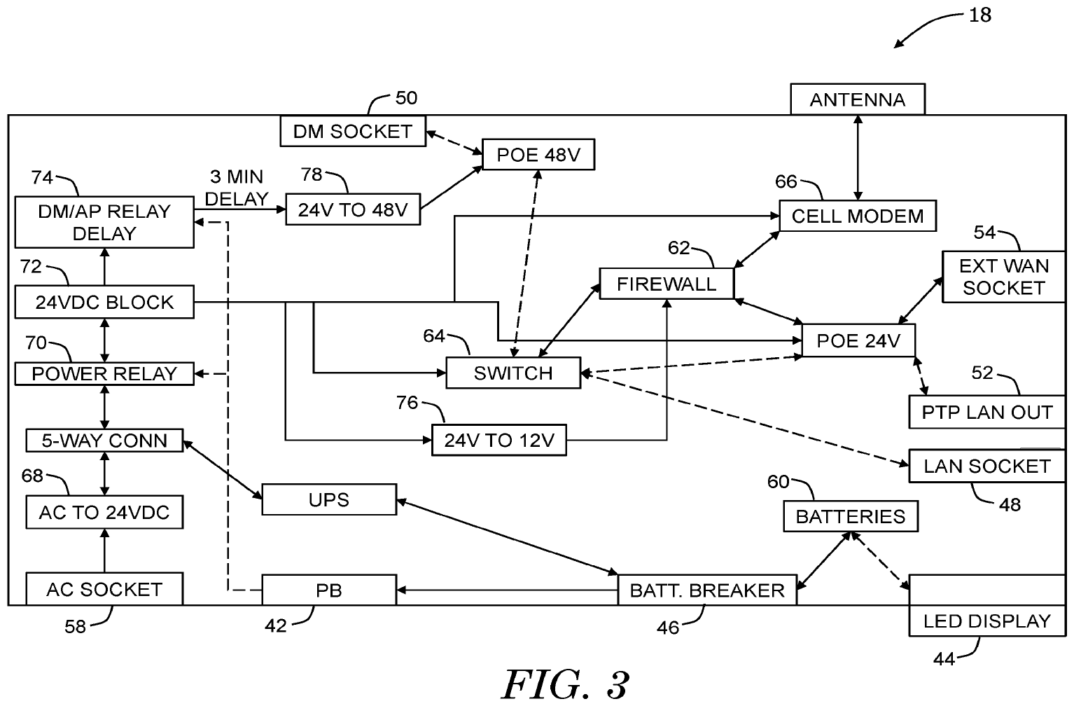

FIG. 2 is a front view of an exemplary base unit 12, 14 of the communication network platform 10 shown in FIG. 1. FIG. 3 is a schematic of various internal components of the network module 18 of the base unit 12, 14. In the exemplary embodiment, the base unit 12, 14 includes a ruggedized container 40 for safe deployment of the base unit 12, 14. The ruggedized container 40 is configured to enclose and secure various components, such as the network module 18 and the distribution module 20, therein. For example, the ruggedized container 40 can include one or more internal compartments (not shown) for safely and securely storing different components of the base unit 12, 14 such as the network module 18, the distribution module 20 (or parts thereof), etc.

As depicted in FIG. 2, the ruggedized container 40 includes a plurality of ports, indicators, displays, and buttons/switches, which are used to facilitate operation of the base unit 12, 14. The ports, indicators, displays, and buttons/switches, for example, are part of the network module 18, as further depicted in FIG. 3.

In an example embodiment, the network module 18 includes a power button 42 that operates to activate a display screen 44. The display screen 44 displays information regarding a status level of one or more internal batteries 60. The network module 18 also includes a battery breaker 46 associated with internal batteries 60. The battery breaker 46 includes, for example, a weather-resistant, user accessible breaker.

In the example, positioned below the power button 42, the display screen 44, and the battery breaker 46, the ruggedized container 40 includes one or more inlet/outlet ports of the network module 18. For example, the network module 18 includes an internet hardline (e.g., VoIP, etc.) connector 48 that enables a network cable to be connected to the network module 18. In the depicted example, the connector 48 is an RJ45 connector having a square receptacle. As described herein, the base units 12, 14 incorporate unique, weather-resistant cables and plugs to facilitate easy, correct connection, for example, between modules. The square receptacle of the connector 48 is configured to connect to a cable assembly having a matching square plug. Thus, the unique plugs and unique connectors of the base unit 12, 14 facilitates easy connection without the possibility of mismatching of differently configured plugs and connectors.

The network module 18 also includes distribution module socket 50 for connection to the distribution module 20, such as a Wi-Fi router/antenna system. In the example embodiment, the distribution module socket 50 is a nine pin (9-pin) connector receptacle. In certain aspects of the invention, the distribution module socket 50 may include a twelve pin (12-pin) connector receptacle to support additional communication bandwidth between the network module 18 and the distribution module 20. It is preferable to locate the distribution module 20 separate from the network module 18 at an adequate height (e.g., on an extended pole) to facilitate increasing the broadcast range of the Wi-Fi signal range. The distribution module 20 is then coupled in communication to the network module 18 via the 9-pin or 12-pin connector receptacle. As described herein, in an embodiment, the system 10 uses advanced Wi-Fi technology, such as an AI-enabled processing system with improved Wi-Fi meshing, that allow for an increased range of Wi-Fi coverage from each distribution module 20.

In the exemplary embodiment, the network module 18 can be further configured to provide for point-to-point (P2P) LAN connectivity. For example, the network module 18 includes a P2P LAN connector 52. In the example, the P2P LAN connector 52 is a round, weatherproof, locking RJ45 connector receptacle for receiving connection from a broadband radio transceiver (not shown). As noted above, the base units 12, 14 incorporate unique weather-resistant cables and plugs. The round receptacle of the connector 52 is configured to connect to a cable assembly having a matching round plug.

In the exemplary embodiment, the network module 18 preferably includes at least one internet/ethernet connector 54 for a direct wired connection to an external computing device (not shown) that facilitates access to the internet 28 (shown in FIG. 1). In the depicted embodiment, the internet/ethernet connector 54 is an RJ45 connector receptacle having a screw-lock receptacle presenting a screw-lock configuration. The screw-lock connection facilitates a secure cable connection to reduce the risk of the internet connection becoming unplugged. As noted above, the base units 12, 14 incorporate unique weather-resistant cables and plugs. The screw-lock receptacle of the connector 54 is configured to connect to a cable assembly having a matching screw-lock plug. In certain embodiments, the internet/ethernet connector 54 can be connected to one or more of a satellite modem, WAN radio, and/or any other communications system that provides connection to the internet 28.

The network module 18 also includes a battery switch 56 for activating the internal batteries 60 of the network module 18. In particular, the battery switch 56 facilitates engaging an electrical connection to the internal batteries 60, while substantially simultaneously disengaging an electrical connection to grid power and/or the power module 22.

The network module 18 includes a power socket 58 for connection to electrical power from, for example, local grid power or the power module 22. In one example, the power socket 58 is a three pin (3-pin) connector receptacle for receiving 120-240 VAC electrical grid power. In another embodiment, the power socket 58 is a seven pin (7-pin) connector receptacle that facilitates the transfer of electrical power and status messages from the power module 22 to the network module 18. In certain aspects, the power socket 58 can be a 7-pin to 11-pin connector to allow for additional internal messaging between the power module 22 and the network module 18.

Referring to FIG. 3, in the example embodiment, the network module 18 broadly includes the internal batteries 60, a network security appliance 62 (or firewall), a network switch 64 for internal and external connections, a cellular modem 66, and the plurality of ports, indicators, displays, and buttons/switches described above. In addition, the network module 18 includes various power supply and distribution components as described below. The internal batteries 60 are provided as a temporary backup power source in the event that main power to the network module 18 is disrupted. Further, the internal batteries 60 may be used for final power smoothing of the primary power source.

The network security appliance 62 is configured to provide network security to the network provided by the system 10. In one embodiment, the network security appliance 62 monitors all data packets that are sent to and from the system 10. Whenever the network security appliance 62 detects an anomaly, the security appliance will prevent the data packets from entering the protected network. In certain embodiments, the network security appliance 62 is configured to block selected network traffic, such as unwanted spam messages and the like. In addition, the network security appliance 62 may be configured to provide virus scanning services to the network, which will automatically scan throughout the network to ensure that no virus exists within the protected network. Furthermore, in some aspects of the invention, the network security appliance 62 may be configured to provide content filtering and firewall services to facilitate the transmission of wanted network traffic through the network and blocking of unwanted or harmful network traffic through the network.

The network switch 64 is configured to connect the various components of the network module 18 and devices connected to the plurality of ports, indicators, displays, and buttons/switches described above. The network switch 64 uses packet switching to receive data from one device and forward the data to a destination device. In the example embodiment, the network switch 64 is a hardened industrial network router/switch that is designed to function in a temperature range between about negative twenty degrees Celsius (−20° C.) and about seventy degrees Celsius (70° C.). Further, the network switch 64 is designed to operate in environments subject to extreme vibrations and shocks. In one or more aspects of the present disclosure, the network switch 64 is configured to provide a one Gigabit (1 Gbit) network backplane.

The cellular modem 66 is configured for radio frequency (RF) transmission and/or reception for communicating with one or more cellular towers and/or radios within range of the base unit 12, 14. Accordingly, the cellular modem 66 functions as a cellular backhaul and may initiate and/or perform communications with the cellular towers and/or other cellular networks as desired or required to facilitate providing access to the internet 28 (shown in FIG. 1). As depicted in FIG. 3, the cellular modem 66 is connected to the network security appliance 62 before connection to the network switch 64, such that network traffic conducted over the cellular modem 66 may be secured.

The network module 18 includes an alternating current (AC) to direct current (DC) converter 68, which converts incoming AC power to twenty-four volt DC (24 VDC). A power relay 70 is coupled to the AC to DC converter 68. The power relay 70 is further connected to the power button 42, which when pressed, actuates the power relay 70 to provide electrical power to a power distribution block 72. The power button 42 further operates to actuate a time-delay relay 74.

The power distribution block 72 is connected to the network security appliance 62 (via a power transformer 76), the network switch 64, the cellular modem 66, and the time-delay relay 74. The power relay 70 and the time-delay relay 74 include, for example, solid-state relays that are configured to control a power-on sequencing process for the network appliances, as described further herein. The power relay 70 may include an instant on relay. In one embodiment, the time-delay relay 74 is an on-delay timer. With an on-delay timer, timing begins when voltage is applied to the relay, for example, by the engagement of power relay 70. When a predetermined period has expired, the contacts of the on-delay timer close, thereby completing the electrical circuit. The contacts remain closed until voltage is removed from the coil of the on-delay timer. If voltage is removed before the predetermined period has expired, the time delay resets. In one embodiment, the time-delay relay 74 is adjustable such that the predetermined period is in a range between and including about one second (1 s) and about ten seconds (10 s). In one preferable embodiment, the predetermined period is in a range between and including about two seconds (2 s) and about five seconds (5 s). In a most preferable embodiment, the predetermined period is about three seconds (3 s).

In the example embodiment, the power transformer 76 is configured to convert twenty-four volt DC (24 VDC) to twelve volt DC (12 VDC) and a power transformer 78 is configured to convert twenty-four volt DC (24 VDC) to forty-eight volt DC (48 VDC). The power transformer 78 is coupled downstream of the time-delay relay 74, and as such, provides power to the distribution module socket 50 after a predetermined period after the power button 42 is engaged.

In the example embodiment, the network module 18 is configured to provide uplink failover. That is, the network module 18 provides failover service for the connection to the internet 28 between the attached network connection devices. Failover priority can be user defined to select between cellular, wired, satellite, LAN/WAN, and/or any other internet connection service coupled to the base unit 12, 14.

### Exemplary Power Module

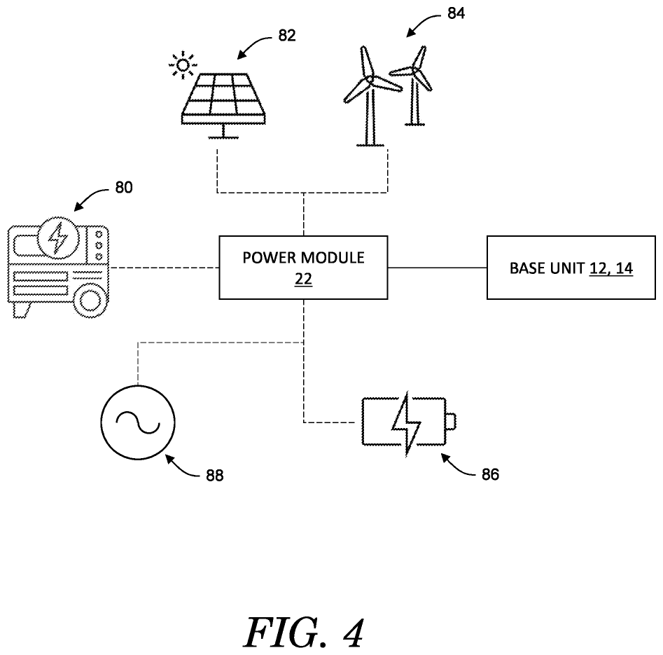

FIG. 4 is a schematic of the power module 22 coupled to a plurality of optional external power sources, in accordance with one aspect of the invention. In the depicted embodiment, the power module 22 may be electrically coupled to one or more of a dual-fuel generator 80, a solar power array 82 (e.g., micro grid solar providing 200-400 watts), a wind generator 84, battery power 86, and/or a hardline connection to an electrical grid 88. These power sources are typically external to the power module 22 and generate, store, and/or provide power for the power module 22 via respectively connected cables.

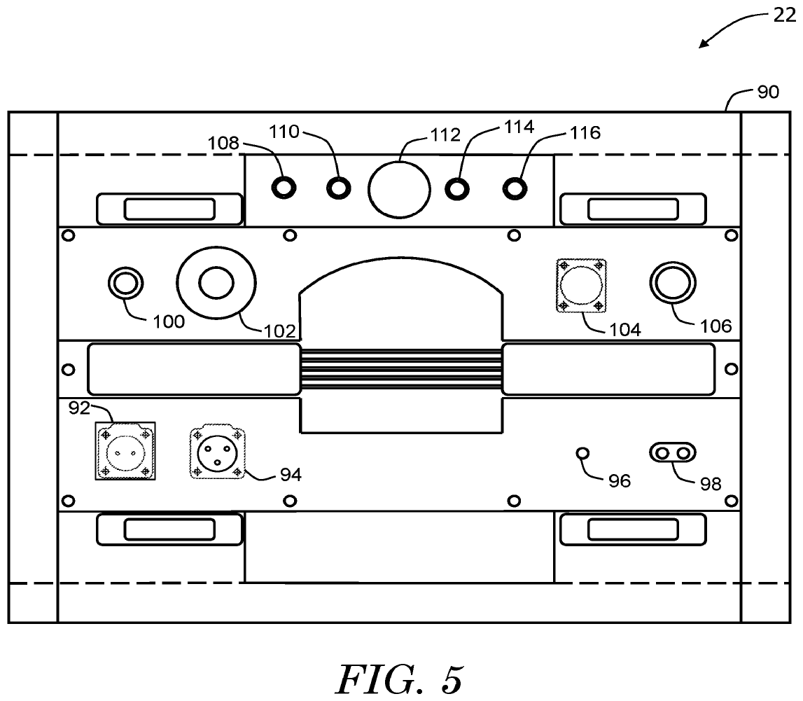

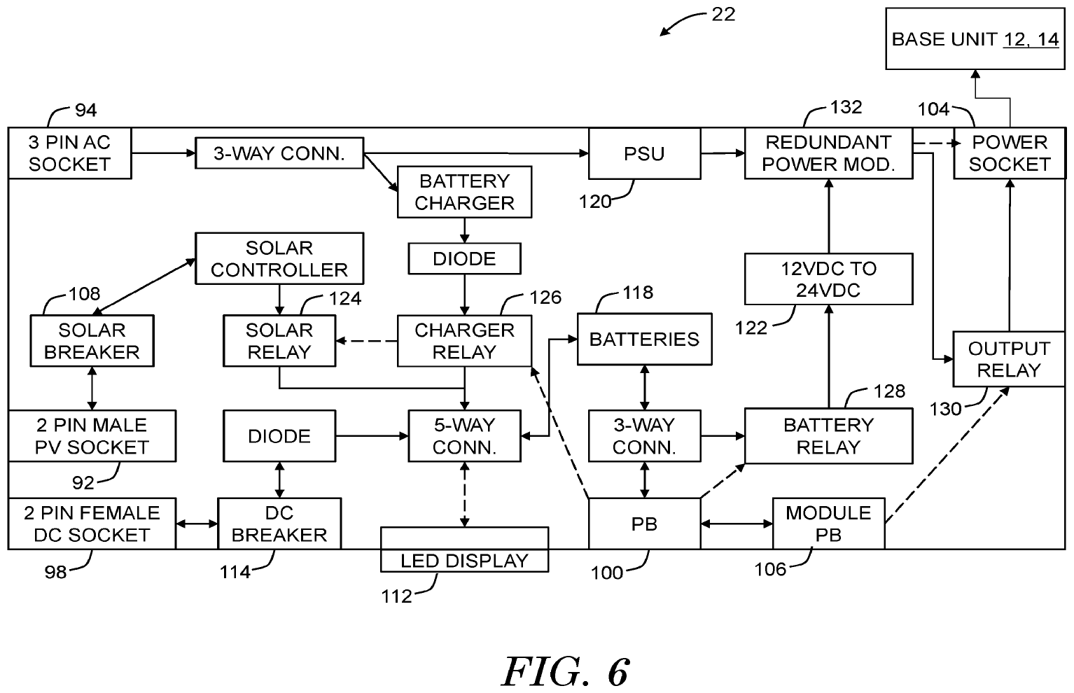

FIG. 5 is a front view of an exemplary power module 22 of the communication network platform 10 shown in FIG. 1. FIG. 6 is a schematic of various internal components of the power module 22. In the exemplary embodiment, the power module 22 is configured to accept electrical power from any available power generation source, and to normalize the provided electrical power to twenty-four volts DC (24 VDC).

In the exemplary embodiment, the power module 22 includes a ruggedized container 90 for safe deployment of the power module 22. The ruggedized container 90 is configured to enclose and secure various components therein. For example, the ruggedized container 90 can include any number of internal compartments (not shown) for safely and securely storing different components of the power module 22.

As depicted in FIG. 5, the ruggedized container 90 includes a plurality of ports, indicators, displays, and buttons/switches, which are used to facilitate operation of the power module 22. In particular, the power module 22 includes input ports for receiving power from the one or more power sources and at least one output port for supplying power to the base unit 12, 14. It will be appreciated that the applicability of a given port, indicator, and/or button/switch will depend upon the external components selected for use with the system (e.g., such as the selected power source shown in FIG. 4). As discussed above, a particular advantage of the system 10 is that the power module 22 and base units 12, 14 are designed with connectors configured to be unique for each component (e.g., unique in shape, size, color, and/or prong/pin number, etc.) so that no particular expertise is necessary to correctly connect the appropriate cables to their respective input or output ports.

Referring to FIGS. 5 and 6, in the example embodiment, the power module 22 includes an input port 92 for connection to a low voltage power source, such as the solar power array 82 or the wind generator 84 (each shown in FIG. 4). In one embodiment, the input port 92 preferably receives twelve (12), twenty-four (24), or thirty-six (36) volts DC (VDC) of power. By way of example, the input port 92 can be configured as a two pin (2-pin) connector receptacle. The input pot 92 is preferably the only 2-pin connector on the power module 22, such that the only power cable (not shown) that can be received by the input port 92 is one having a corresponding 2-pin mating connector. The power cable is likewise configured at an opposite end for attachment to the solar power array 82 or wind generator 84 used to generate power for this power source option. As such, users without technical expertise can correctly connect the selected power source to the correct input port with limited instruction, simply because the mating element for the selected power cable will only fit into the input port 92, for example.

The power module 22 includes an input port 94 for connecting to an alternative or additional power source. The input port 94 may be configured as a three pin (3-pin) connector receptacle. The configuration of the input port 94 facilitates receiving power from a higher voltage source, such as a one hundred and twenty to two hundred and forty volts AC (120-240 VAC) power source. Such a power source may include, for example, the hardline connection to an electrical grid 88 (shown in FIG. 4) or from a fuel powered generator, such as the dual-fuel generator 80 (shown in FIG. 4). The input port 94 is preferably the only 3-pin connector on the power module 22, such that the only power cable (not shown) that can be received by the input port 94 is a power cable having a corresponding 3-pin mating connector. The power cable is likewise configured at an opposite end for attachment to the external high voltage source (e.g., via a 2- or 3-prong plug) to supply the power module 22 with the selected power source option.

In the example embodiment, the power module 22 includes a ground lug 96. The ground lug 96 facilitate grounding of the power module 22, for example, when the solar power array 82 or the wind generator 84 is used for external power. In addition, the power module 22 includes an input port 98 for connecting the power module 22 to an external battery power source, such as battery power 86 (e.g., additional twelve volt DC (12 VDC) batteries wired in parallel to provide external power). Each of the ground lug 96 and the input port 94 presents a unique configuration to facilitate easy connection.

The exemplary power module 22 includes a power button 100 that operates to activate a display screen 112. In the depicted configuration, when engaged, the display screen 112 displays battery voltage details of the internal batteries 118 of the power module 22. The internal batteries 118 are provided as a temporary backup power source in the event that main power to the power module 22 is disrupted. The internal batteries 118 are configured to provide up to about four (4) hours of battery backup for a fully deployed base unit 12, 14 with up to two hundred and fifty (250) Wi-Fi connections. Further, the internal batteries 118 may be used for final power smoothing of the primary power source. To save power, the power module 22 can be configured to dim or turn off the display screen 112 or any other light indicators, until or unless the power button 100 is engaged.

As depicted in FIG. 5, the exemplary power module 22 also includes a battery switch 102 for activating the internal batteries 118 of the power module 22. In particular, the battery switch 102 facilitates engaging an electrical connection to the internal batteries 118, while substantially simultaneously disengaging an electrical connection to external power sources.

Referring to FIGS. 5 and 6, the power module 22 includes a power socket 104 for connection to the network module 18 (i.e., the base unit 12, 14). In one example, the power socket 104 is a seven pin (7-pin) connector receptacle that facilitates the transfer of electrical power and status messages from the power module 22 to the network module 18. In certain aspects, the power socket 104 can be a 7-pin to 11-pin connector to allow for additional internal messaging between the power module 22 and the network module 18. Adjacent to the power socket 104, the power module 22 includes an inter-module power button 106 configured to activate the power socket 104 for supplying power and status messages to the network module 18.

In the example embodiment, the power module includes a plurality of breakers 108, 110, 114, and 116 across the upper portion of the ruggedized container 90. In particular, a respective one of the breakers 108, 110, 114, and 116 is associated with a respective on of the input ports 92, 94, and 98, and the power socket 104. Each breaker 108, 110, 114, and 116 is configured to prevent/enable the flow of electrical current through the respective port/socket. For example, the breaker associated with the power socket 104 is configured to stop the supply of power to the power socket 104, and thus to the network module 18.

As depicted in FIG. 6, the power module 22 includes various industrially rated components for managing and transforming an input power source to the power requirements of the base unit 12, 14 (e.g., 24 VDC). For example, the power module 22 includes an industrially rated AC/DC power supply unit (PSU) 120, industrially rated transformer equipment 122, and analog power management equipment, such as a plurality of solid-state power relays 124, 126, 128, and 130.

It will be appreciated that references herein to “buttons” or “switches” are used for ease of reference with respect to the embodiments exemplified herein, but should be interpreted to encompass any variety of manually activated mechanical or electrical operating members for engaging/activating or disengaging/deactivating their respective elements, including, without limitation, toggle switches, rocker switches, slider switches, rotary switches, push-button switches, as well as a variety of key switch locks. It also will be appreciated that in discussions of connectors, either side may be configured to be the connector element having apertures for receiving the corresponding mating pin elements from the other half of a connection pair. Further, it is contemplated that alternative connector types or configurations may be used beyond those exemplified in FIGS. 2-6. For example, connectors having more or less pins or other connection means could be used without departing from the scope of the disclosure. It is noted however, that each input and output port is to remain clearly physically or visually distinguishable from the others on each module (e.g., the network module 18 and the power module 22) to facilitate set up without expert knowledge and with limited instruction. Moreover, the various ports may be further covered by a cap or suitable plug or other form of protection to prevent damage or deformation of the port or debris during transport. Preferably, the caps or plugs are tethered to the module body to prevent loss when they are removed to uncover the port for use.

### Exemplary Methods of Operation

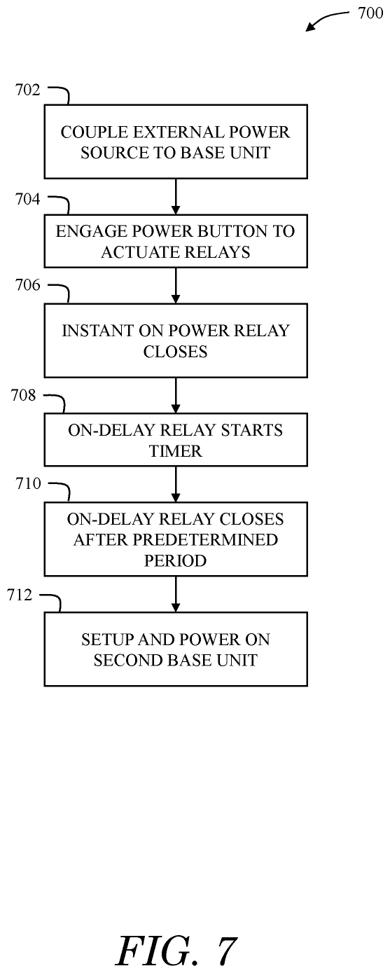

FIG. 7 is a flowchart illustrating an exemplary computer-implemented method 700 for deploying a secure telecommunications infrastructure, such as the communication network platform or system 10 (shown in FIG. 1), in remote and/or austere environments. The operations described herein may be performed in the order shown in FIG. 7 or may be performed in a different order. Furthermore, some operations may be performed concurrently as opposed to sequentially. In addition, some operations may be optional.

The computer-implemented method 700 is described below, for ease of reference, as being executed by the exemplary devices and components introduced with the embodiments illustrated in FIGS. 1-6. In one embodiment, the method 700 may be implemented by the base unit 12, 14 (shown in FIG. 1). While operations within the method 700 are described below regarding the base unit 12, 14, the method 700 may be implemented on other such computing devices and/or systems through the utilization of processors, transceivers, hardware, software, firmware, or combinations thereof. However, a person having ordinary skill will appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

At operation 702, an external power source is coupled to the power socket 58 of the base unit 12 (shown in FIG. 1). As described herein, the external power source may include local grid power (e.g., via a hardline, wall plug, etc.) and/or the power module 22. At operation 704, the power button 42 is engaged, which causes the power relay 70 and the time-delay relay 74 to be engaged. Engaging the power button 42 also opens connection to the internal batteries 60 for power smoothing and backup.

Upon engagement of the power relay 70, at operation 706, the power relay 70 closes and electrical power from the external power source is substantially immediately routed to the network security appliance 62, the network switch 64, and the cellular modem 66, causing these components to be powered first. Upon engagement of the time-delay relay 74, at operation 708, a predetermined timing period is initiated.

At operation 710, after the predetermined timing period has expired, the time-delay relay 74 closes and electrical power from the external power source is routed to the distribution module 20, causing the distribution module 20 to be powered after the network security appliance 62, the network switch 64, and the cellular modem 66. After the distribution module 20 is powered on and connected through the network module 18 to the internet 28 (e.g., via cellular, radio link, direct connection through copper or optical fiber services, and the like), the Wi-Fi network (e.g., via the wireless access point 38a) is available and ready for end users to connect their computing devices 36a-n thereto. In certain embodiments, any add-on and/or special modules, if present, would be energized and connected to the network switch 64 in the network module 18, allowing operation and use.

Optionally, at an operation 712, a second base unit 14 (shown in FIG. 1) may be setup and powered on in substantially the same manner as described above. When individual base units 14 are located in desired proximity to a primary base unit 12 and activated, each will automatically establish a meshed communication link with the primary base unit 12 and any other local base unit 14 able to be contacted and connected to.

After a connection to the internet 28 is established, the base unit 12 acts as a relay station for receiving and transmitting data to and from the internet and in turn, to and from the distribution module(s) 20 associated with each connected base unit 12, 14. In this manner, user computing devices 36a-n can connect to the wireless network (e.g., the wireless access points 38a, 38b) enabled by the base units 12, 14. The user computing devices 36a-n can transmit/receive data or other information to/from the internet via the base units 12, 14. In addition, any communication between user computing devices 36a-n connected to the meshed base units 12, 14 will be enabled without need of the internet. User computing devices 36a-n connected to the same network of base units 12, 14 will be internally managed and allowed to communicate through the routing protocols of the directly connected distribution modules 20 and the networking modules 18.

As such, it will be appreciated that the network module 18 of each base unit 12, 14 will include signal processing systems and content delivery networks configured to transmit, receive, decode, encode, etc. digital and/or analog signals between the IP capable devices. Techniques for programming such systems are known in the art and/or commercially available.

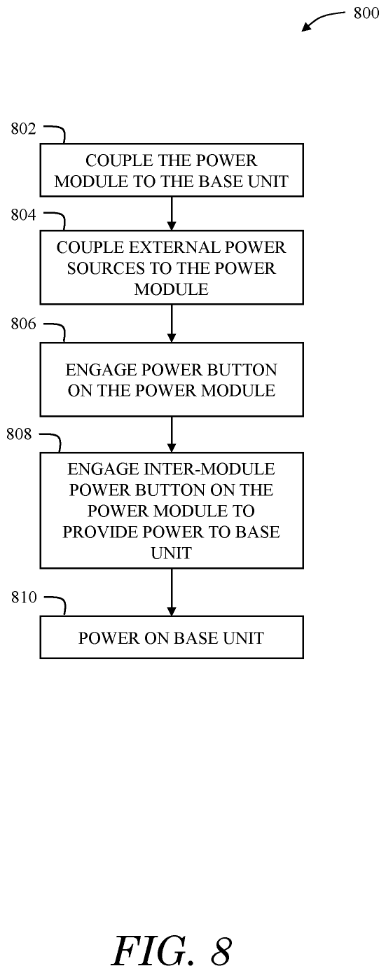

FIG. 8 is a flowchart illustrating another computer-implemented method 800 for deploying a secure telecommunications infrastructure, such as the communication network platform or system 10 (shown in FIG. 1), in remote and/or austere environments. The operations described herein may be performed in the order shown in FIG. 8 or may be performed in a different order. Furthermore, some operations may be performed concurrently as opposed to sequentially. In addition, some operations may be optional.

The computer-implemented method 800 is described below, for ease of reference, as being executed by the exemplary devices and components introduced with the embodiments illustrated in FIGS. 1-6. In one embodiment, the method 800 may be implemented by the base unit(s) 12, 14 and the power module 22 (shown in FIG. 1). While operations within the method 800 are described below regarding the base unit(s) 12, 14, and the power module 22, the method 800 may be implemented on other such computing devices and/or systems through the utilization of processors, transceivers, hardware, software, firmware, or combinations thereof. However, a person having ordinary skill will appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

In operation 802, the power module 22 is electrically coupled to the base unit 12. More particularly, a first end of a power cable (not shown) is attached to the power socket 104 of the power module 22 and a second end of the power cable is attached to the power socket 58 of the base unit 12, 14 (i.e., the network module 18).

At operation 804, one or more external power sources are coupled to the power module 22. For example, as described herein, the external power sources may include one or more of a dual-fuel generator 80, a solar power array 82 (e.g., micro grid solar providing 200-400 watts), a wind generator 84, battery power 86, and/or a hardline connection to an electrical grid 88.

At operation 806, the power button 100 of the power module 22 is engaged, which causes a plurality of solid-state power relays 124, 126, and 128 to be engaged. Engaging the power button 100 also opens connection to the internal batteries 118 for power smoothing and backup. More particularly, after connection of the one or more external power sources to the power module 22, the power button 100 is engaged and energizes the PSU 120 and opens the circuit to the redundant power module 132 (shown in FIG. 6).

At operation 808, the inter-module power button 106 of the power module 22 is engaged, which causes the output relay 130 to be engaged. The output relay 130 is configured to activate the power socket 104 for supplying power and status messages to the network module 18 of the base unit 12, 14. At operation 810, the base unit 12, 14 may then be powered on in the manner describe above with respect to method 700.

It will be appreciated that advantages of the various embodiments described herein include, for example, connections to and between base units 12, 14 and/or the power module 22 using unique cables and plugs, making it impossible to incorrectly connect the cables. Further, the system 10 provides flexible utilization of internet connections and available power sources. As described, the base units 12, 14 automatically mesh (with only six millisecond (6 ms) of latency per hop between units) using cutting edge AI and Blockchain technologies to provide stable, expandable coverage area, which facilitates scalability to cover large areas (e.g., up to sixty kilometers (60 km) between deployed base units 12, 14). The base units 12, 14 employ industrially rated internal communication components that provide minimal loss of throughput at each base units 12, 14 to maintain high throughput network wide. In addition, the base units 12, 14 may employ long distance P2P broadband radio links for interconnection up to sixty kilometers (60 km). Moreover, the portability of the base units 12, 14 is maintained because each base unit 12, 14 and/or power module 22 is configured to weighs less than fifty pound (50 lbs), including internal batteries.

### ADDITIONAL CONSIDERATIONS

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein. For example, in one or more embodiments, the required power components from the power module 22 could be integrated into the network module 18 as a single module, eliminating the separate power module 22, at the request of an end user that requires such a configuration for use and deployment; such as a trailer or vehicle mounted system, for a permanent installation where a single source of power is permanently available, or for any similar situation.

Although the present application sets forth a detailed description of numerous different embodiments, it should be understood that the legal scope of the description is defined by the words of the claims and equivalent language. The detailed description is to be construed as exemplary only and does not describe every possible embodiment because describing every possible embodiment would be impractical. Numerous alternative embodiments may be implemented, using either current technology or technology developed after the filing date of this patent, which would still fall within the scope of the claims. Those of ordinary skill in the art will appreciate that any suitable combination of the previously described embodiments may be made without departing from the spirit of the present invention.

In this disclosure, reference be made to several terms, which shall be defined to have the following meanings. The singular forms “a,” “an,” and “the” include plural references unless the context clearly dictates otherwise. “Optional” or “optionally” means that the subsequently described event or circumstance may or may not occur, and that the description includes instances where the event occurs and instances where it does not.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

Approximating language, as used herein throughout the specification and the claim, may be applied to modify any quantitative representation that could permissibly vary without resulting in a change in the basic function to which it is related. Accordingly, a value modified by a term or terms, such as “about,” “approximately,” and “substantially” are not to be limited to the precise value specified. In at least some instances, the approximating language may correspond to the precision of an instrument for measuring the value. Here and throughout the specification and claim, range limitations may be combined and/or interchanged. Such ranges are identified and include all the sub-ranges contained therein unless context or language indicates otherwise.

As used herein, the phrase “and/or,” when used in a list of two or more items, means that any one of the listed items can be employed by itself or any combination of two or more of the listed items can be employed. For example, if a composition is described as containing or excluding components A, B, and/or C, the composition can contain or exclude A alone; B alone; C alone; A and B in combination; A and C in combination; B and C in combination; or A, B, and C in combination.

The present description also uses numerical ranges to quantify certain parameters relating to various embodiments of the invention. It should be understood that when numerical ranges are provided, such ranges are to be construed as providing literal support for claim limitations that only recite the lower value of the range as well as claim limitations that only recite the upper value of the range. For example, a disclosed numerical range of about 1 to about 250 provides literal support for a claim reciting “greater than about 1” (with no upper bounds) and a claim reciting “less than about 250” (with no lower bounds).

Unless specifically stated otherwise, discussions herein using words such as “presenting,” “displaying,” “processing,” “computing,” “calculating,” “determining,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached figures, it is noted that equivalents may be employed, and substitutions made herein, without departing from the scope of the disclosure as recited in the claims.

Having thus described various embodiments of the disclosure, what is claimed as new and desired to be protected by Letters Patent includes the following:

1. A base station comprising:
a ruggedized container;
a distribution module comprising a Wi-Fi access point; and
a network module securely mounted in the ruggedized container and coupled in communication with the distribution module, the network module comprising:
a cellular backhaul comprising a cellular modem coupled in communication with a cellular network;
a network switch; and
network security appliance coupled in communication with the cellular modem and the network switch, the network security appliance being located between the cellular modem and the network switch such that data communications between the cellular modem and the network switch pass through the network security appliance.

2. The base station in accordance with claim 1,
said network module further comprising one or more internal batteries, the internal batteries configured to operate as a temporary backup power source and provide power smoothing of a primary power source.

3.-5. (canceled)

6. The base station in accordance with claim 1,
said network module further comprising an instant on power relay and a time-delay relay configured to control a power-on sequencing process for the base station,
said instant on power relay configured to cause electrical current to flow to the network security appliance, the network switch, and the cellular modem.

7.-9. (canceled)

10. The base station in accordance with claim 6, said time-delay relay configured to cause electrical current to flow to the distribution module after a predetermined period wherein the predetermined period is about three seconds (3 s).

11. The base station in accordance with claim 1, said network module further comprising a plurality of inlet/outlet ports, the plurality of inlet/outlet ports having connectors configured to be unique for each respective inlet/outlet to prevent incorrect assembly thereof.

12. The base station in accordance with claim 11, wherein the plurality of inlet/outlet ports comprises:
an internet hardline connector having a receptacle;
a point-to-point (P2P) LAN connector having a receptacle; and
an internet/ethernet connector having a receptacle, wherein each of said receptacles has a unique shape, size, color, prong number, and/or pin number.

13. The base station in accordance with claim 1, said network module further comprising a distribution module socket,
wherein the network module is coupled in communication with the distribution module via the distribution module socket.

14. The base station in accordance with claim 1, said network module further comprising a power socket configured to connect to an external power source.

15. A rapidly deployable communications system comprising:
a first base station comprising:
a first distribution module comprising a first wireless communication device; and
a first network module comprising:
a cellular backhaul comprising a cellular modem coupled in communication with a cellular network for providing a first internet source; and
a first plurality of inlet/outlet ports;
a second base station comprising:
a second distribution module comprising a second wireless communication device; and
a second network module comprising a second plurality of inlet/outlet ports; and
one or more additional distribution modules, each including an additional wireless communication device,
wherein each of the first plurality of inlet/outlet ports and the second plurality of inlet/outlet ports include connectors configured to be unique for each respective port to prevent incorrect assembly thereof,
wherein the second base station and the one or more additional distribution modules are coupled in wireless communication with the first base station via the first wireless communication device, the second wireless communication device, and the additional wireless communication devices.

16. The rapidly deployable communications system in accordance with claim 15,
said first wireless communication device comprising a first Wi-Fi access point implementing the IEEE 802.11ax standard,
said second wireless communication device comprising a second Wi-Fi access point implementing the IEEE 802.11ax standard,
said additional wireless communication device comprising an additional Wi-Fi access point implementing the IEEE 802.11ax standard,
wherein the second base station is coupled in wireless communication with the one or more additional distribution modules and the first base station via Wi-Fi meshing between the first Wi-Fi access point, each additional wireless communication device, and the second Wi-Fi access point.

17. The rapidly deployable communications system in accordance with claim 15,
said first wireless communication device comprising a first five gigahertz (5 GHz) radio providing up to a five kilometer (5 km) connection range,
said second wireless communication device comprising a second 5 GHz radio providing up to a five kilometer (5 km) connection range,
wherein the first and second base stations are coupled in wireless communication with the one or more additional distribution modules via the first and second 5 GHz radios, respectively.

18. The rapidly deployable communications system in accordance with claim 15,
said first wireless communication device comprising a first long range radio providing up to a sixty kilometer (60 km) connection range,
said second wireless communication device comprising a second long range radio providing up to a sixty kilometer (60 km) connection range,
wherein the second base station is coupled in wireless communication with the first base station via point-to-point (P2P) long range wireless communication between the first long range radio and the second long range radio.

19. The rapidly deployable communications system in accordance with claim 15,
wherein one of the first plurality of inlet/outlet ports is coupled in communication to a second internet source,
said first network module being configured to provide failover service between the first internet source and the second internet source.

20. The rapidly deployable communications system in accordance with claim 15, further comprising a power module coupled to one of the first and second base stations to provide electrical power thereto.

21. A rapidly deployable communications system comprising:
a base station comprising:
a first distribution module coupled thereto, the first distribution module comprising a first wireless communication device; and
a network module comprising:
a cellular backhaul comprising a cellular modem coupled in communication with a cellular network for providing a first internet source; and
a plurality of inlet/outlet ports; and
a second distribution module comprising a second wireless communication device,
wherein the plurality of inlet/outlet ports include connectors configured to be unique for each respective port to prevent incorrect assembly thereof,
wherein the second distribution module is coupled in wireless communication with the base station via the first wireless communication device and the second wireless communication device.

22. The rapidly deployable communications system in accordance with claim 21,
said first wireless communication device comprising a first Wi-Fi access point implementing the IEEE 802.11ax standard,
said second wireless communication device comprising a second Wi-Fi access point implementing the IEEE 802.11ax standard,
wherein the second distribution module is coupled in wireless communication with the base station via Wi-Fi meshing between the first Wi-Fi access point and the second Wi-Fi access point.

23. The rapidly deployable communications system in accordance with claim 21,
said first wireless communication device comprising a first five gigahertz (5 GHz) radio providing up to a five kilometer (5 km) connection range,
said second wireless communication device comprising a second 5 GHz radio providing up to a five kilometer (5 km) connection range,
wherein the first base station is coupled in wireless communication with the second distribution module via the first and second 5 GHz radios, respectively.

24. The rapidly deployable communications system in accordance with claim 21,
wherein a first one of the plurality of inlet/outlet ports is coupled in communication to a second internet source,
wherein a second one of the plurality of inlet/outlet ports is coupled in communication to the first distribution module,
said first network module being configured to provide failover service between the first internet source and the second internet source.

25. The rapidly deployable communications system in accordance with claim 21, further comprising a power module coupled to one of the plurality of inlet/outlet ports to provide electrical power to the base station.

26. The base station in accordance with claim 1, said network module further comprising one or more of a satellite connection, a wide area network (WAN) connection, a local area network (LAN) connection, or a wireless point-to-point (P2P) connection.
